(19) United States
(12) Patent Application Publication
(10) Pub. No.: US 2010/0186285 A1
(43) Pub. Date: Jul. 29, 2010

(54) ARRANGEMENT FOR DESTROYING VERMIN

(76) Inventor: Robert Schmitt, Schweinfurt (DE)

Correspondence Address: LUCAS & MERCANTI, LLP, 475 PARK AVENUE SOUTH, 15TH FLOOR, NEW YORK, NY, 10016, US

(21) Appl. No.: 12/670,448

(22) PCT Filed: Jul. 19, 2008
(86) PCT No.: PCT/EP2008/005932

§ 371 Date: Jan. 25, 2010

(30) Foreign Application Priority Data
Jul. 25, 2007 (DE) 10 2007 035 152.8
Jan. 8, 2008 (DE) 10 2008 003 394.4

(51) Int. Cl. A01M 1/20; A01M 1/22; A01M 1/06

(52) U.S. Cl. 43/132.1; 43/124; 43/139; 43/144

(57) ABSTRACT

The invention relates to an arrangement for destroying vermin (2). To ensure a quick and certain dispatch of the vermin and to depollute is efficiently the arrangement according to the invention comprises: a device (3) for the generation of an airflow in a conveying channel (4), wherein the conveying channel (4) has an intake opening (6) for vermin (2) at one end (5), a filter element (7) which is arranged in the conveying channel (4), wherein the filter element (7) is designed to detain vermin (2) and to allow air to pass and wherein a disposal opening (8) for vermin (2) is arranged in the area of the filter element (7) and at least one radiation device and/or at least one heating device (9) for emitting a radiation (10) which dispatches the vermin (2), wherein the radiation device and/or the heating device (9) is arranged between the intake opening (6) and the filter element (7) along the conveying channel (4) or in an area abutting on the same.

The invention relates to an arrangement for destroying vermin

The disruption by vermin is a daily occurrence in a lot of countries. Specifically cockroaches are disruptive as they sometime transfer diseases or sting human beings.

The elimination of vermin with poison does not only have negative surrounding circumstances, because the poison can reach the organisms, which should no be affected. Furthermore, resistances have already been observed which have been developed by the vermin so that the poison remains ineffective.

The dispatch of vermin with mechanical means has also drawbacks and is incidentally very unhygienic.

Thus, it is the object of the invention to create an apparatus for the elimination of vermin, especially cockroaches, which does not have the mentioned disadvantages. The vermin should be reliably dispatched and depolluted hygienically. Furthermore, the apparatus should he characterized by an efficient mode of operation.

The solution of this object by the invention is characterized in that the arrangement comprises:
a device for the generation of an airflow in a conveying channel, wherein the conveying channel has an intake opening for vermin at one end,
a filter element which is arranged in the conveying channel, wherein the filter element is designed to detain vermin and to allow air to pass and wherein a disposal opening for vermin is arranged in the area of the filter element and
at least one radiation device and/or at least one heating device for emitting a radiation which dispatches the vermin, wherein the radiation device and/or the heating device is arranged between the intake opening and the filter element along the conveying channel or in an area abutting on the same.

For the design of the radiation and heating device respectively different possibilities are available which can also be employed very beneficially in combination.

The radiation device is preferably an element which generates electromagnetic waves. Here, especially preferred an element is suggested which generates microwaves.

Alternatively or additively a radiation device can be employed which is a lamp which emits red light.

The heating device can be employed alone or in combination with a radiation device. An ohmic resistance can be utilized as a heating device. According to an embodiment of the invention it is designed as a heating coil.

The device for the generation of an airflow is preferably a suction unit of a vacuum cleaner.

The filter element can be designed as a perforated plate. In this case it is beneficial when the perforated plate has holes which have a diameter between 1 mm and 4 mm. Of course, it is also possible that the filter element is a fibrous filter which is preferably exchangeable.

A collection container for vermin can be arranged in the area of the disposal opening for vermin.

A conveying element can be arranged between the intake opening and the filter element, which conveying element is designed for conveying of vermin to the disposal opening. In this case the conveying element can preferably be designed as a mechanical conveying element, wherein specifically preferred a screw conveyor is suggested, which is arranged in a housing. Here, the screw conveyor consists preferably of ceramic material to resist microwave radiation or also heat radiation without problems.

According to a preferred embodiment of the invention the conveying element conveys the vermin in a direction transverse to the flow direction of the airflow in the conveying channel.

Thereby, the radiation device and the heating device respectively are preferably arranged around the conveying element. The radiation device and the heating device respectively can thereby be arranged outside of the conveying channel and adjacent to the same.

A blocking device can be arranged in the conveying channel close to the intake opening which blocking device prevents the escape of vermin from the conveying channel. Correspondingly, it can be further provided that a blocking device is arranged in the direction of the airflow in the end region of the conveying channel which blocking device prevents the escape of vermin from the conveying channel. According to a preferred embodiment the blocking device comprises a plurality of biased lamellas which form together a closure of the conveying channel.

The proposed apparatus can be designed as a mobile unit. In this case it is an advantage when the apparatus comprises a battery for the supply of the device for the generation of an airflow and of the radiation device and heating device respectively. Furthermore, it is well-proven that the apparatus comprises straps for carrying at the back like a backpack.

Alternatively, the apparatus can be designed as a stationary unit. Thereby a specific solution provides that the apparatus is part of a central vacuum cleaning device.

The intake opening is preferably designed for the connection of a flexible tube of a vacuum cleaner, by which the vermin can be sucked in.

With the proposed apparatus it is possible to dispatch larger amounts of vermin quickly and reliably. Due to the construction of the apparatus the vermin can be sucked in the apparatus hygienically and can he passed into a collection container after dispatch.

The device can be utilized in a flexible way when being designed as a mobile unit. But it is also possible to provide the device as a stationary unit, wherein the apparatus can be integrated into the central vacuum cleaner system of a building.

It is essential that the apparatus comprises at least one radiation device and/or at least one heating device by which radiation in the broadest sense can be generated and can be directed to the vermin. This radiation can be a microwave radiation or a heat radiation which intensity is selected in any case in such a way that a quick dispatch of the vermin occurs.

In the drawing embodiments of the invention are shown.

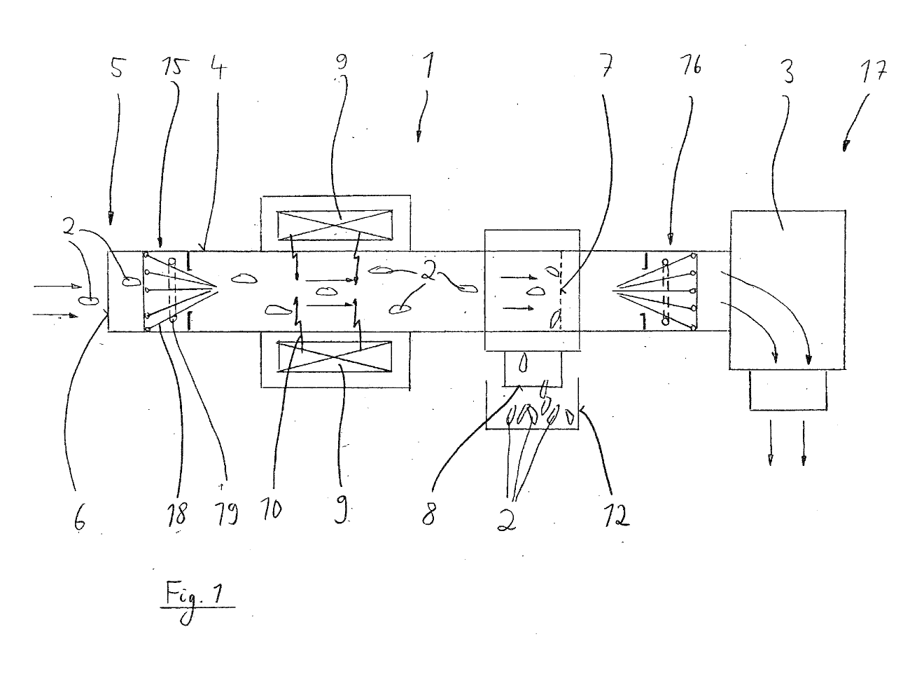

FIG. 1 shows the cross section of an apparatus for destroying vermin, wherein the required parts are partly depicted only very schematically and

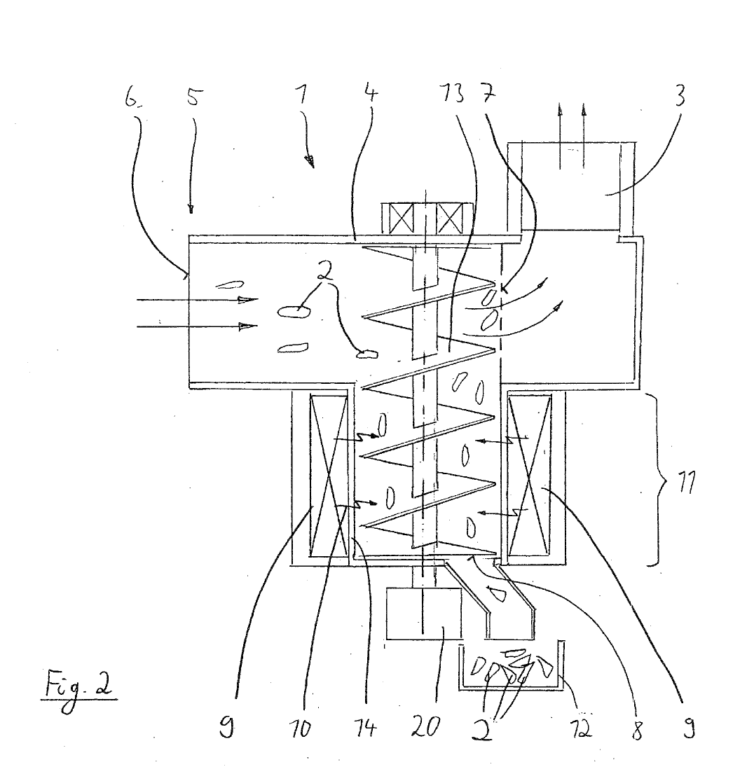

FIG. 2 shows a cross section of an apparatus as an embodiment which is an alternative to FIG. 1, which has a conveying element for conveying of vermin.

In FIG. 1 an apparatus 1 for the elimination of vermin 2 is shown, wherein the vermin is depicted only very schematically. Mostly, the vermin are cockroaches which are to be eliminated in a simple and efficient way. The typical sizes and weights of the cockroaches are 10 till 50 mm length and up to 5 grams in weight.

According to the embodiment the apparatus 1 has a longitudinally extending conveying channel 4. It can also be provided that the conveying channel 4 is curved or has a meander shape. At a suitable location a device 3 for the generation of an airflow is arranged at or in the conveying channel 4. This device 3 is a suction unit of a vacuum cleaner which is known as such. In the present case the device 3 is positioned at the rear end 17 of the conveying channel 4. Generally, the device 3 can be positioned in the conveying channel 4 at any position. The airflow which is generated by the operation of the device 3 is schematically depicted by arrows.

At the front end 5 of the conveying channel an intake opening 6 is arranged by which air is sucked in, wherein vermin 2 is carried away by the airflow. In the conveying channel 4 a filter element 7 is arranged which consists of a perforated plate in the rudimentary case in which holes are machined with a diameter between 2 and 4 mm. The diameter of the holes is selected in such a way that air can pass the filter element 7 without problems but vermin 2 is held off reliably.

Of course the filter element can also consist of a classical filter material which is arranged in the conveying channel 4 exchangeably. The exchange of the filter material is beneficial with respect to the hygiene.

Near the filter element 7 and namely below the same a disposal opening 8 for vermin 2 is arranged in the conveying channel 4. Below the disposal opening 8 a collection container 12 is arranged which can take up vermin 2.

Blocking devices 15 and 16 are provided so that no vermin 2 which is sucked channel 4. In the embodiment elements according to the type of a fyke are employed. A plurality of lamellas 18 is provided which are arranged around the circumference of the conveying channel 4 which has preferably a circular cross section, wherein the lamellas 18 are biased by a spring 19 so that the blocking device 15, 16 closes the conveying channel 4 in the unladen state.

However, air can pass the blocking device 15, 16. The dimensioning of the spring 19 is chosen in such a way that the lamellas 18 open elastically in the case when vermin 2 is aspirated and thus allow the entry of vermin 2 into the conveying channel 4.

A radiation device and heating device 9 respectively is an important part of the apparatus, by which a radiation 10 (as the case may be also a heat radiation) can be emitted which dispatches the vermin 2.

Preferably, the radiation device 9 is a microwave source. Microwave generating elements are well known in the state of the art, e. g. from microwave ovens.

In the case of the use of a heating device 9 mostly a heating coil is employed which is heated up as an ohmic resistance correspondingly so that the heat radiation dispatches the vermin quickly.

The radiation device and heating device 9 respectively is arranged in the embodiment according to FIG. 1 between the intake opening 6 and the filter element 7 in the area of the conveying channel 4. Thereby, the vermin must pass necessarily the radiation device and heating device respectively after suction via the intake opening 6 and before filtering by the filter element 7.

During operation of the apparatus 1 the radiation device 9 produces a radiation field, especially a microwave field, which is so strong that the vermin is reliably dispatched when passing the radiation device 9. Correspondingly, the heating device produces such a heat radiation which also ensures a quick dispatch of the vermin.

In the embodiment according to FIG. 2 a somewhat different configuration can be seen. This solution has a more compact construction of the apparatus 1. An area 11 is laterally abutting on the conveying channel 4, wherein the channel section of the area 11 runs approximately perpendicular to the longitudinal axis of the conveying channel 4.

In addition to the embodiment according to FIG. 1 a mechanical conveying element 13 which is a screw conveyor is provided in the solution according to FIG. 2. The longitudinal axis of the screw 13 is presently perpendicular to the longitudinal axis of the conveying channel 4. The screw 13 can be rotationally driven by a motor 20. During operation it conveys vermin 2 downwardly to the disposal opening 8, wherefrom the vermin 2 reaches the collection container 12.

Thereby, the screw 13 is arranged in a housing 14. The conveying channel 4 as well as the housing 14 have a circular cross section. Correspondingly, also the filter element 7 is circular arc shaped bent around the screw 13. This causes that during operation the screw 13 reliably conveys vermin from the filter clement 7 downwards which vermin is arranged in front of the filter element 7 still in the airflow.

The radiation device and heating device 9 respectively is arranged here in the abutting area 11 so that the vermin 2 passes the region only during conveying downwardly by the screw 13 in which it is exposed to a lethal radiation.

Beneficially, the passing velocity of the vermin 2 when passing the radiation device and heating device 9 respectively is determined by the rotation of the screw. By this is can be assured that the radiation is sufficient in any case to dispatch the vermin.

It is not depicted in detail that the whole apparatus 1 must of course be shielded in such a way that radiation—equal if it is microwave radiation or heat radiation—which is emitted by the radiation device and heating device 9 respectively cannot reach the ambient. Corresponding solutions are known in the state of the art, e. g. from the technology of microwave ovens; insofar reference is made hereupon. Apart from this a thermal insulation is provided to ensure especially in the case of using a heating device that the apparatus does not become too hot at its outer surface.

The conveying channel 4 is made preferably from a metallic material for this purpose, so that electromagnetic waves cannot leave the inside of the channel. The blocking devices 15, 16 serve also for the shielding which detain radiation in the inside of the channel 4 due to its explained design.

The selection of the field force of the electromagnetic field of the radiation device, especially of the field force of the microwave radiation and the heating power of the heating device 9 respectively, is done in such a way that the vermin 2 can be heated up in a very short time and can thus be dispatched.

The whole apparatus 1 can be carried like a backpack wherefore corresponding carrying straps are arranged at the apparatus and the apparatus is then placed in a corresponding portable housing respectively.

A flexible vacuum cleaner tube is then connected in a known manner to the intake opening 6 so that the vermin can be aspirated easily.

### REFERENCE NUMERALS

1 Apparatus

2 Vermin

3 Device for the generation of an airflow

4 Conveying channel

5 End of the conveying channel

6 Intake opening

7 Filter element

8 Disposal opening

9 Radiation device/heating device
(microwave source/heating element)

10 Radiation

11 Area abutting on the conveying channel

12 Collection container

13 Conveying element (screw conveyor)

14 Housing

15 Blocking device

16 Blocking device

17 End of the conveying channel

18 Lamella

19 Spring

20 Motor

1-27. (canceled)

28. Apparatus for destroying vermin, comprising:
a device for the generation of an airflow in a conveying channel, wherein the conveying channel has an intake opening for vermin at one end,
a filter element which is arranged in the conveying channel, wherein the filter element is designed to detain vermin and to allow air to pass and wherein a disposal opening for vermin is arranged in the area of the filter element and
at least one radiation device and/or at least one heating device for emitting a radiation which dispatches the vermin, wherein the radiation device and/or the heating device is arranged between the intake opening and the filter element along the conveying channel or in an area abutting on the same,
wherein a conveying element is arranged between the intake opening and the filter element, which conveying element is designed for conveying of vermin to the disposal opening, and wherein the conveying element is designed as a mechanical conveying element in the form of a screw conveyor, which is arranged in a housing.

29. Apparatus according to claim 28, wherein the radiation device is an element which generates electromagnetic waves.

30. Apparatus according to claim 29, wherein the radiation device is an element which generates microwaves.

31. Apparatus according to claim 30, wherein the radiation device is a lamp which emits red light.

32. Apparatus according to claim 28, wherein the heating device is an ohmic resistance, especially in the form of a heating coil.

33. Apparatus according to claim 28, wherein the device for the generation of an airflow is a suction unit of a vacuum cleaner.

34. Apparatus according to claim 28, wherein the filter element is designed as a perforated plate, wherein the perforated plate preferably has holes which have a diameter between 1 mm and 4 mm.

35. Apparatus according to claim 28, wherein a collection container for vermin is arranged in the area of the disposal opening for vermin.

36. Apparatus according to claim 28, wherein the screw conveyor consists of ceramic material or of glass.

37. Apparatus according to claim 28, wherein the conveying element conveys the vermin in a direction transverse to the flow direction of the airflow in the conveying channel.

38. Apparatus according to claim 28, wherein the radiation device and/or the heating device is arranged around the conveying element.

39. Apparatus according to claim 28, wherein the apparatus is designed as a mobile unit, wherein it preferably comprises straps for carrying at the back like a backpack.

40. Apparatus according to claim 28, wherein the apparatus is designed as a stationary unit.

41. Apparatus according to claim 40, wherein the apparatus is part of a central vacuum cleaning device.

42. Apparatus according to claim 28, wherein the intake opening is designed for the connection of a flexible hose of a vacuum cleaner.
